(19) United States
(12) Patent Application Publication
(10) Pub. No.: US 2009/0077640 A1
(43) Pub. Date: Mar. 19, 2009

(54) SYSTEM AND METHOD FOR VALIDATING USER IDENTIFICATION

(75) Inventor: TZAN-FU WANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,024

(22) Filed: Dec. 29, 2007

(30) Foreign Application Priority Data
Sep. 14, 2007 (CN) 200710201705.X

(51) Int. Cl. G06F 21/00

(52) U.S. Cl. 726/5

(57) ABSTRACT

A method for validating user identification includes the steps of: guiding a user to input a user ID through a login interface; comparing the user ID with original identifications stored in a database (40) and determining whether the user ID matches one of the original identifications; sending validation information to a mobile phone number corresponding to the original identification; updating an original password, corresponding to the original identification, according to the validation information; running a validation program, installed in a mobile phone having the mobile phone number, to decrypt the validation information, and generating a validation result as a login password; inputting the login password through the login interface, and transmitting the inputted login password to an application server (30); and determining whether the inputted login password is the same as the updated password. A system for validating user identification is also provided.

### BACKGROUND OF THE INVENTION

1. Field of the Invention

The present invention relates, generally, to systems and methods for validating user identification.

2. Description of Related Art

Because computer networks are used for sharing information and for other business purposes, people become more and more dependent on them. For example, some people often search for relevant information through the computer network, or obtain important personal and business data from a network server. Generally, before obtaining data from the network server, users are required to login to the network server by inputting their identification and corresponding password. However, the security of the password may be compromised because of the threat of hackers or viruses. Once the password is stolen, the entire network is at risk of being compromised.

Accordingly, what is needed is a system and method for validating user identification and password securely.

### SUMMARY OF THE INVENTION

One preferred embodiment provides a system for validating user identification. The system includes an application server, and a database connected to the application server. The application server includes a login module, a determining module, a sending module, and a password updating module. The database is configured for storing original identifications, original passwords, and a mobile phone number of each of a plurality of users. The login module is configured for providing a login interface for a client, and guiding a user to input a user identification (ID) through the login interface. The determining module is configured for comparing the user ID with the original identifications stored in the database, and determining whether the user ID matches one of the original identifications. The sending module is configured for sending validation information to a mobile phone number corresponding to the original identification. A validation program installed in a mobile phone having the mobile phone number decrypts the validation information and generates a validation result as a login password of the application server. The password updating module is configured for updating an original password, corresponding to the original identification, according to the validation information. The login module is further configured for inputting the login password through the login interface of the client, and transmitting the inputted login password to the application server. The determining module is further configured for confirming whether the user is allowed to access the application server by determining whether the inputted login password is the same as the updated password.

Another preferred embodiment provides a method for validating user identification. The method includes the steps of: Providing a client, an application server, and a database connected to the application server, the database stores original identifications, original passwords and a mobile phone number of each of a plurality of users; providing a login interface for the client, and guiding a user to input a user identification (ID) through the login interface; comparing the user ID with the original identifications stored in the database and determining whether the user ID matches one of the original identifications; sending validation information to a mobile phone number corresponding to the original identification, if the user ID matches one original identification stored in the database; updating an original password, corresponding to the original identification, according to the validation information; running a validation program, installed in a mobile phone having the mobile phone number, to decrypt the validation information, and generating a validation result as a login password of the application server; inputting the login password through the login interface of the client, and transmitting the inputted login password to the application server; and confirming whether the user is allowed to access the application server by determining whether the inputted login password is the same as the updated password.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for validating user identification in accordance with one preferred embodiment.

FIG. 2 is a flowchart of a method for validating user identification in accordance with the preferred embodiment.

### DETAILED DESCRIPTION OF THE INVENTION

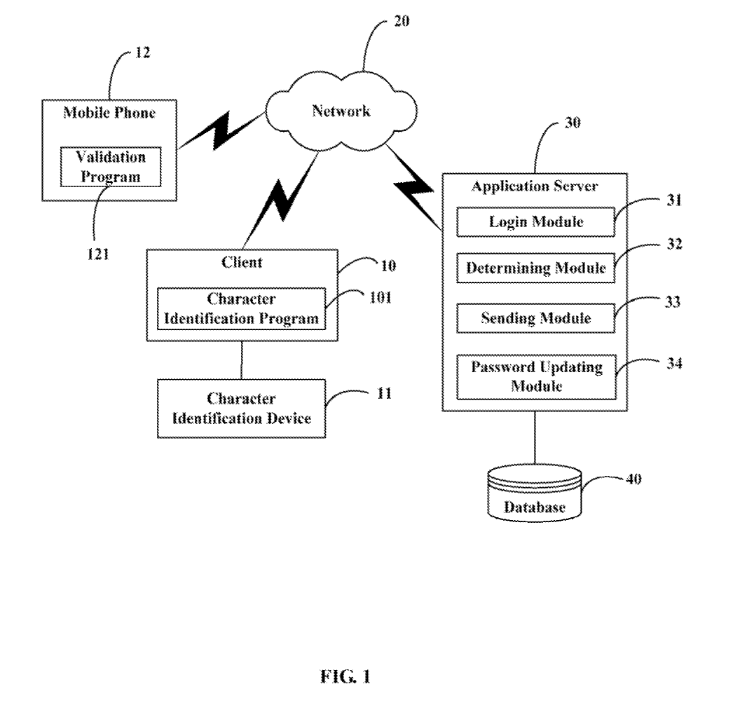

FIG. 1 is a block diagram of a system for validating user identification (hereinafter “the system”) in accordance with one preferred embodiment. The system typically includes at least one client 10, a character identification device 11 connected with the client 10, a mobile phone 12, a network 20, an application server 30, and a database 40 connected with the application server 30. The client 10, the mobile phone 12, and the application server 30 are connected with each other for convenient communication via the network 20.

The client 10 may be, but not limited to, a personal digital assistant (PDA), a laptop or desktop computer. The client 10 provides a browser for browsing a login interface provided by the application server 30, and a character identification program 101. The character identification device 11 may be, but not limited to, a fingerprint identification device or a camera. In the preferred embodiment, the client 10 and the mobile phone 12 are two independent devices (as shown in FIG. 1); and in other embodiments, the client 10 and the mobile phone 12 may be a combination, the character identification program 101 is installed in the mobile phone 12, and the character identification device 11 is directly connected with the mobile phone 12.

The database 40 is configured for storing personal data and relevant data of each of a plurality of users. The personal data includes original identification, original password, a mobile phone number, and original character data of each of the users. The original character data includes original fingerprint data and original head portrait data.

The application server 30 typically includes a login module 31, a determining module 32, a sending module 33, and a password updating module 34.

The login module 31 is configured for providing the login interface for the client 10, and guiding a user to input a user identification (ID) through the login interface.

The determining module 32 is configured for comparing the user ID with the original identifications stored in the database 40, and determining whether the user ID matches one of the original identifications.

The sending module 33 is configured for sending validation information to a mobile phone number corresponding to the original identification.

The password updating module 34 is configured for updating an original password, corresponding to the original identification, according to the validation information. The password updating module 34 is further configured for generating an updated password corresponding to the original identification.

A validation program 121 is installed in the mobile phone 12. After received the validation information, the mobile phone 12 runs the validation program to decrypt the validation information, and generates a validation result as a login password of the application server 30. The login password is the same as the updated password that was generated by the password updating module 34.

The character identification program 101 installed in the client 10 is configured for obtaining character data of the user through the character identification device 11. The character data includes fingerprint data and head portrait data.

The login module 31 is further configured for inputting the login password and the character data through the login interface, and transmitting the inputted login password and the inputted character data to the application server 30.

The determining module 32 is further configured for confirming whether the user is allowed to access the application server 30 by determining whether the inputted login password is the same as the updated password corresponding to the original identification, and by determining whether the inputted character data is the same as the original character data corresponding to the original identification. If the inputted login password is the same as the updated password and the inputted character data is the same as the original character data, the user is allowed to access the application server 30. If the inputted login password is not the same as the updated password, or the inputted character data is not the same as the original character data, the user is denied to access the application server 30.

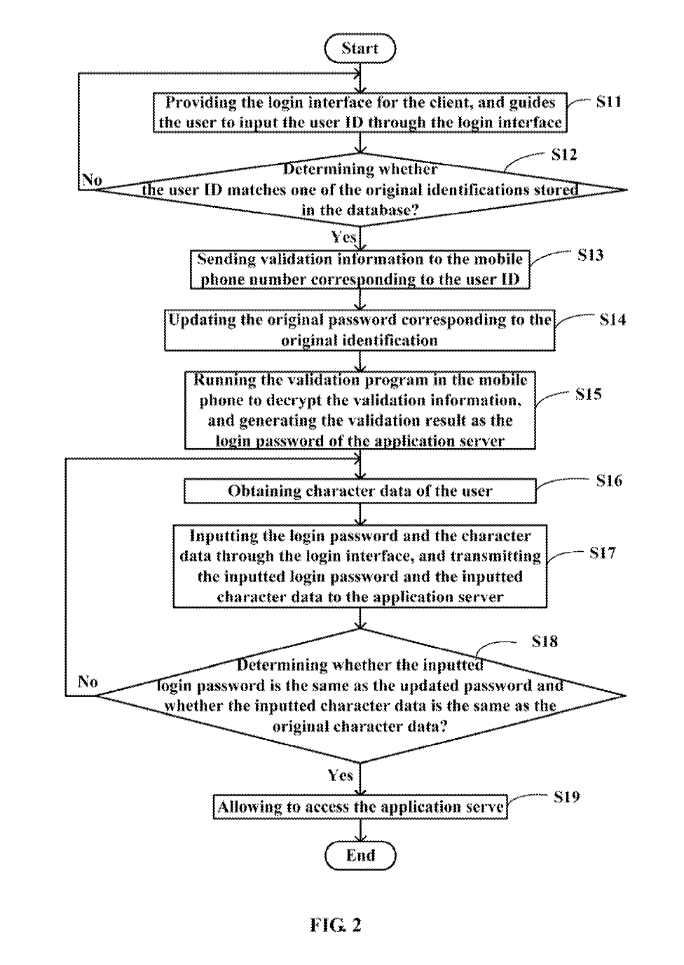

FIG. 2 is a flowchart of a method for validating user identification in accordance with the preferred embodiment.

In step S11, the login module 31 provides the login interface for the client 10, and guides the user to input the user ID through the login interface.

In step S12, the determining module 32 compares the user ID with the original identifications stored in the database 40, and determines whether the user ID matches one of the original identifications.

In step S13, the sending module 33 sends the validation information to the mobile phone number corresponding to the user ID, if the user ID matches one original identification stored in the database 40.

In step S14, the password updating module 34 updating the original password, corresponding to the original identification, according to the validation information.

In step S15, the mobile phone 12 receives the validation information, runs the validation program 121 to decrypt the validation information, and generates the validation result as the login password of the application server 30. The login password is the same as the updated password.

In step S16, the client 10 obtains character data of the user through the character identification device 11 and the character identification program 101. The character data includes fingerprint data and head portrait data.

In step S17, the login module 31 inputs the login password and the character data through the login interface of the client 10, and transmits the inputted login password and the inputted character data to the application server 30.

In step S18, the determining module 32 confirms whether the user is allowed to access the application server by determining whether the inputted login password is the same as the updated password corresponding to the original identification, and whether the inputted character data is the same as the original character data corresponding to the original identification.

In step S19, if the inputted login password is the same as the updated password and the inputted character data is the same as the original character data, the user is allowed to access the application server 30.

In the step S12, if the user ID does not matches with any original identifications stored in the database 40, the user is prompted that the inputted user ID is false, and then the procedure returns to the step S11.

In the step S18, if the inputted login password is not the same as the updated password, or the inputted character data is not the same as the original character data, the user is prompted that the login password is false, and then the procedure returns to the step S16.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for validating user identification, comprising:
a database configured for storing original identifications, original passwords, and a mobile phone number of each of a plurality of users;
an application server, connected to the database, comprises:
a login module configured for providing a login interface for a client, and guiding a user to input a user identification (ID) through the login interface;
a determining module configured for comparing the user ID with the original identifications stored in the database, and determining whether the user ID matches one of the original identifications;
a sending module configured for sending validation information to a mobile phone number corresponding to the original identification, a validation program, installed in a mobile phone having the mobile phone number, decrypts the validation information and generates a validation result as a login password of the application server;
a password updating module configured for updating an original password, corresponding to the original identification, according to the validation information;
the login module further configured for inputting the login password through the login interface of the client, and transmitting the inputted login password to the application server; and
the determining module further configured for confirming whether the user is allowed to access the application server by determining whether the inputted login password is the same as the updated password.

2. The system according to claim 1, wherein the database is further configured for storing original character data of each of a plurality of users, the original character data corresponding to the original identifications, the original passwords, and the mobile phone number.

3. The system according to claim 2, wherein the original character data comprises original fingerprint data and original head portrait data.

4. The system according to claim 2, wherein the client comprises a character identification program configured for obtaining character data of the user through a character identification device connected with the client.

5. The system according to claim 4, wherein the login module is further configured for inputting the character data through the login interface, and transmitting the inputted character data to the application server.

6. The system according to claim 5, wherein the determining module is further configured for determining whether the inputted character data is the same as the original character data corresponding to the original identification.

7. A method for validating user identification, the method comprising the steps of:
providing a client, an application server, and a database connected to the application server, the database stores original identifications, original passwords and a mobile phone number of each of a plurality of users;
providing a login interface for the client, and guiding a user to input a user identification (ID) through the login interface;
comparing the user ID with the original identifications stored in the database and determining whether the user ID matches one of the original identifications;
sending validation information to a mobile phone number corresponding to the original identification, if the user ID matches one original identification stored in the database;
updating an original password, corresponding to the original identification, according to the validation information;
running a validation program, installed in a mobile phone having the mobile phone number, to decrypt the validation information, and generating a validation result as a login password of the application server;
inputting the login password through the login interface of the client, and transmitting the inputted login password to the application server; and
confirming whether the user is allowed to access the application server by determining whether the inputted login password is the same as the updated password.

8. The method according to claim 7, wherein the database is further configured for storing original character data of each of a plurality of users, the original character data corresponding to the original identifications, the original passwords, and the mobile phone number.

9. The method according to claim 8, wherein the original character data comprises original fingerprint data and original head portrait data.

10. The method according to claim 7, wherein the client is connected with a character identification device, and is installed a character identification program.

11. The method according to claim 10, further comprising the steps of:
obtaining character data of the user through the character identification device and the character identification program;
inputting the character data through the login interface;
transmitting the inputted character data to the application server; and determining whether the inputted character data is the same as the original character data corresponding to the original identification.
